(19) United States
(12) Patent Application Publication
(10) Pub. No.: US 2005/0011107 A1
(43) Pub. Date: Jan. 20, 2005

(54) Fishing gear

(76) Inventor: Minoru Hiragaki, Shizuoka (JP)

Correspondence Address: KANESAKA AND TAKEUCHI, 1423 Powhatan Street, Alexandria, VA, 22314, US

(21) Appl. No.: 10/790,193

(22) Filed: Mar. 2, 2004

(30) Foreign Application Priority Data
Jul. 16, 2003 (JP) 2003-275036

(51) Int. Cl. A01K 91/00

(52) U.S. Cl. 43/44.9

(57) ABSTRACT

This invention provides a fishing gear which, when a terminal tackle is thrown into water upon surf casting, is capable of preventing the terminal tackle from clinging to a fishing gut. A bottom section is provided on one side of a cylindrical accommodation main body including a cavity section internally while an opening section is provided on the other side, a lid body is provided freely detachably on an opening section of this accommodation main body through a fixing means and plural weight bodies are accommodated within the cavity section of the accommodation main body and the space section of the lid body.

### BACKGROUND OF THE INVENTION

1. Field of the Invention

The present invention relates to a fishing gear which upon surf casting, is capable of preventing fishing terminal tackles from clinging to a line when the fishing device is thrown into water.

2. Description of the Related Art

As a fishing gear used for surf casting on the seashore, there is well known an entirely integrated balance weight 74, in which as shown in FIG. 10, a heavy weight 71 with a float 70 is attached to a line attachment lever 72 composed of wire and a leader attachment lever 73 composed of wire is attached to this line attachment lever 72 rotatably.

This line attachment lever 72 and the leader attachment lever 73 are likely to cling to each other because of ring-like sections 75a, 76a provided on these end sections and when the fishing terminal tackles are thrown in, the leader attachment lever 73 is not always bent at substantially 90° sideway as shown in FIG. 10, so that the fishing terminal tackles with a fishhook may cling to this weight 74, which is a problem to be solved.

### SUMMARY OF THE INVENTION

The present invention has been achieved to solve the above-described problem and an object of the invention is to provide a fishing gear in which a bottom section is provided on one side of a cylindrical accommodation main body including a cavity section internally while an opening section is provided on the other side, a lid body is provided freely detachably on an opening section of this accommodation main body through a fixing means and plural weight bodies are accommodated within the cavity section of the accommodation main body and the space section of the lid body, so that when a terminal tackle is thrown into water upon surf casting, the terminal tackle can be prevented from clinging to a fishing gut.

To achieve the above-described object, according to an aspect of the present invention, there is provided a fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of the accommodation main body and the space section in the lid body, wherein the lid body is formed substantially conically such that it is narrowed gradually from the opening section of the accommodation main body, a first inner cylindrical member is provided in the center of the cavity section in the accommodation main body toward the lid body so that an end section thereof is in contact with the bottom section of the accommodation main body while the other end section of the first inner cylindrical member is extended up to the opening section in the accommodation main body, a second inner cylindrical member is provided in the center of the space section in the lid body toward the accommodation main body so that it is in contact with the end section of the substantially conical section of the lid body while a predetermined separation gap is formed between the other end of the second inner cylindrical member and the other end section of the first inner cylindrical member thereby preventing both the other end sections from making contact, and a connection fishing line is passed through the inner cylindrical member freely movably so that both the end sections of the connection fishing line are brought out of the outer end sections of the accommodation main body and the lid body.

According to another aspect of the present invention, there is provided a fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of the accommodation main body and the space section in the lid body, wherein the lid body is formed substantially conically such that it is narrowed gradually from the opening section of the accommodation main body, an inner cylindrical member is provided substantially in the center section of the accommodation main body and lid body in the axial direction of the accommodation main body and the lid body, a connection fishing line is passed through the inner cylindrical member freely movably so that both the end sections of the connection fishing line are brought out of the outer end sections of the accommodation main body and the lid body, a protective member is engaged with the connection fishing line protruded from the side of the accommodation main body, and the connection fishing line is provided with a means for restricting a move of the connection fishing line in the length direction thereof at the bottom section of the accommodation main body.

According to still another aspect of the present invention, there is provided a fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of the accommodation main body and the space section in the lid body, wherein the lid body is formed substantially conically such that it is narrowed gradually from the opening section of the accommodation main body, a first inner cylindrical member is provided in the center of the cavity section in the accommodation main body toward the lid body so that an end section thereof is in contact with the bottom section of the accommodation main body while the other end section of the first inner cylindrical member is extended up to the opening section in the accommodation main body, a second inner cylindrical member is provided in the center of the space section in the lid body toward the accommodation main body so that it is in contact with the end section of the substantially conical section of the lid body while a predetermined separation gap is formed between the other end of the second inner cylindrical member and the other end section of the first inner cylindrical member thereby preventing both the other end sections from making contact, a protective member which is a member separate from the second inner cylindrical member is engaged with the connection fishing line protruded from the side of the accommodation main body while this engagement is performed by passing the connection fishing line through a hallow section in the protective member, the connection fishing line is provided such that it can swing freely around the outer end section of the bottom of the accommodation main body, so that the protective member engaged with the connection fishing line can rotate freely sideway and the connection fishing line is provided with a means for restricting a move of the connection fishing line in the length direction thereof at the bottom section of the accommodation main body.

Preferably, the top end of the connection fishing line passed through the first inner cylindrical member and the second inner cylindrical member freely movably is connected to a line and a terminal tackle attached to a leader is connected to the bottom end of the connection fishing line, and the connection fishing line, the line and the leader are made of fishing gut and the connection fishing line, the line and the leader are connected straight to each other.

Preferably, the inside diameter of the hallow section formed within the inner cylindrical member is formed in a tapered form such that the inside diameter of the rear end section of the inner cylindrical member is larger than the inside diameter of the front end section of the inner cylindrical member.

### BRIEF DESCRIPTION OF THE DRAWINGS

FIG. 1 is a longitudinally sectional view showing an embodiment of the fishing gear of the present invention;

FIG. 2 is a perspective view showing the fishing gear in FIG. 1 in disassembly;

FIG. 3 is a longitudinally sectional view showing other embodiment of the fishing gear in FIG. 1;

FIG. 4 is an explanatory diagram showing a state in which the fishing gear in FIG. 1 is thrown away;

FIG. 5 is a sectional view of major sections indicating the fishing gear in FIG. 1 in enlargement;

FIG. 6 is a sectional view of major sections indicating other embodiment of the fishing gear in enlargement;

FIG. 7 is a sectional view showing a state in which a curved configuration is formed at each of front end section and rear end section as an example of protective member of the fishing gear in FIG. 1;

FIG. 8 is an explanatory diagram showing usage condition of the fishing gear shown in FIG. 1;

FIG. 9 is an explanatory diagram showing a rotation condition of the protective member under usage condition of the fishing gear shown in FIG. 1; and

FIG. 10 is an explanatory diagram showing usage condition of a conventional fishing weight (for surf casting).

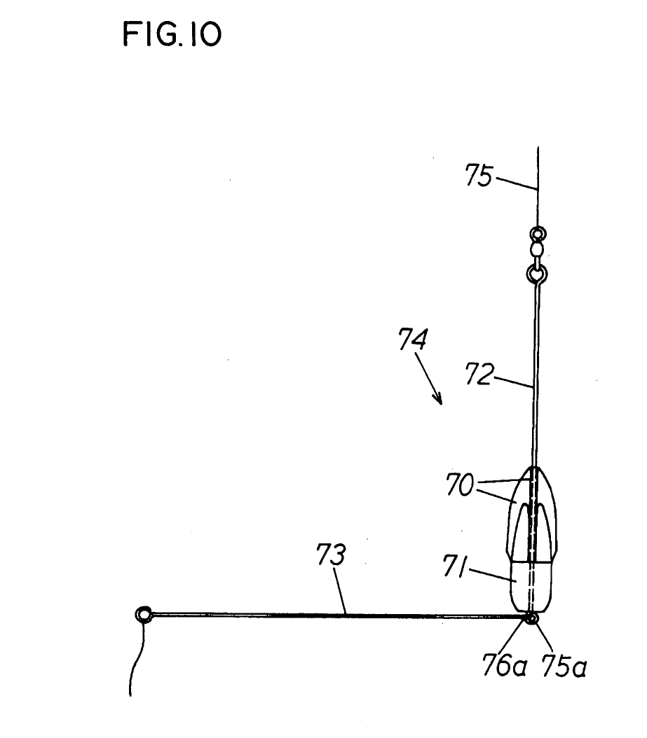

### DESCRIPTION OF THE PREFERRED EMBODIMENTS

An embodiment of the fishing gear according to the present invention will be described with reference to the accompanying drawings.

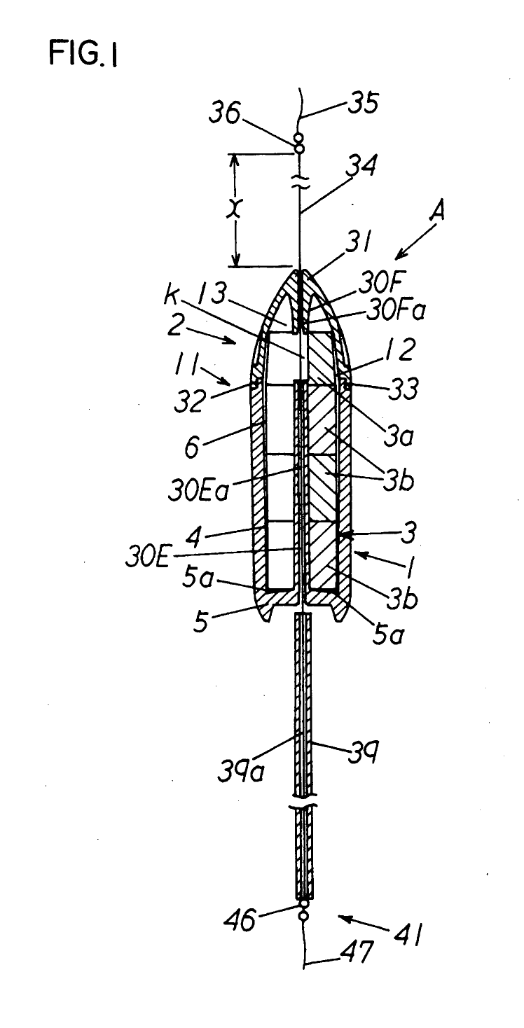

A in FIGS. 1, 3-6, 8, 9 denotes a fishing gear, which is used for surf casting terminal tackle and basically comprises an accommodating main body 1, a lid body 2 and a weight body 3.

The aforementioned accommodation main body 1 is formed into a longitudinally long cylinder having a circular section or polygonal section using rigid synthetic resin or the like. A through cavity section 4 is provided internally and a bottom section 5 is provided at one side section (at a position which is always directed downward upon usage) such that the entire bottom is sealed and an opening section 6 is provided at the other side section (at a position which is always directed upward upon usage).

The bottom section 5 of the accommodation main body 1 is so formed that its outer peripheral section is substantially smooth or a dented section which is dented inward is formed as shown in FIGS. 1, 4-6.

The outer peripheral section of this accommodation main body 1 has outer side section having no hole or gap for preventing sand or foreign matter from entering as shown in FIG. 1.

The lid body 2 is provided such that one side section thereof can be attached or detached to/from the opening section 6 of the accommodation main body 1 through a fixing means 11. The mounting section (one side section 12) of the opening section 6 has the same sectional shape as the accommodation main body 1 and is composed of the same material as the accommodation main body 1, so that a space section 13 is formed inside.

This lid body 2 is formed substantially conically such that it becomes narrower gradually from the opening section 6 of the accommodation main body 1, namely one side section 12 of the lid body 2. A through hole 31 is provided at a position corresponding to substantially the center position in the traverse direction of the lid body 2 or at an end section of that substantial conical shape.

Further, the outer peripheral section of this lid body 2 has an outer side section provided with no hole or gap so as to prevent such any foreign matter as sand from entering as shown in FIG. 1.

That is, the outer peripheral sections of the accommodation main body 1 and lid body 2 are provided with no hole or gap which allows foreign matter such as water, sand from invading into the cavity section 4 in the accommodation main body 1 or a space section 13 in the lid body 2 except a line attachment section (through hole 31).

The aforementioned fixing means is provided so as to allow the accommodating main body 1 and the lid body 2 to be attached to or detached from each other. For example, the attachment is performed by meshing an engagement inner edge 32 such as a male screw provided in the opening section 6 of the accommodation main body 1 with an engagement receiving section 33 such as a female screw provided on the side section 12. Any appropriate means can be selected as long as it allows easy attachment/detachment.

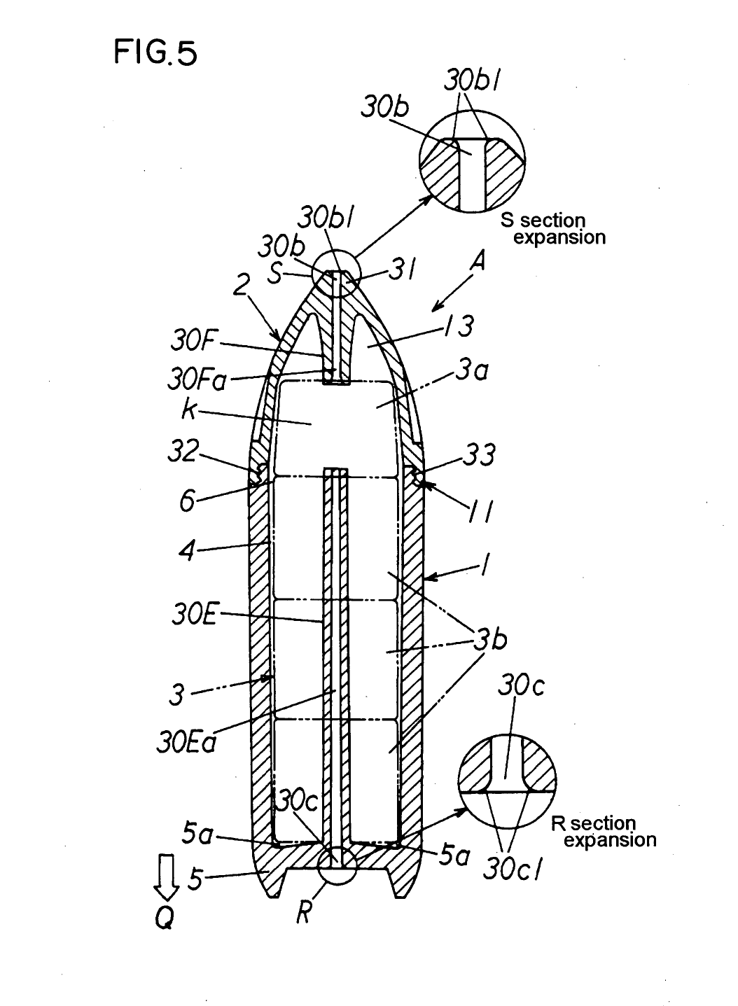

As shown in FIGS. 1, 5 and the like, a first inner cylindrical member 30E is provided in the center portion (in the direction of fishing line) in the cavity section 4 of the accommodation main body 1 toward the lid body 2 such that an end section thereof is contacted with the bottom section of the accommodation main body 1 while the other end section of the first inner cylindrical member 30E is extended up to the opening section 6 of the accommodation main body 1.

A second inner cylindrical member 30F is provided in the center portion (in the direction of the fishing line) in the space section 13 of the lid body 2 toward the accommodation main body 1 such that an end section thereof is contacted with the narrowed end section of the substantially conical section of the lid body 2 while the other end section of the second inner cylindrical member 30F is extended with a predetermined separation gap k which keeps that other end section from contacting the other end section of the first inner cylindrical member 30E.

These first inner cylindrical member 30E and second inner cylindrical member 30F are provided so that their axes coincide with each other and include pipe-like hallow sections 30Ea, 30Fa which allows a connection fishing line 34 which will be described later, to pass freely.

Due to the formation of the predetermined separation gap k which keep the other end section of the second inner cylindrical member 30F from making contact with the other end section of the first inner cylindrical member 30E, foreign matter such as water and sand which invades into a hallow section 30Fa in the second inner cylindrical member 30F never flows directly into a hallow section 30Ea in the first inner cylindrical member 30E and most of them is introduced into the cavity section 4. Thus, the connection fishing line 34 within the hallow section 30Ea in the first inner cylindrical member 30E is never worn or damaged by this foreign matter such as sand.

Foreign matter which flows into the cavity section 4 can be deposited in a concave foreign matter sump 5a provided in the bottom section of the accommodation main body 1. Thus, the foreign matter can be cleaned off by removing the lid body 2 and weight body 3 from the accommodation main body 1 appropriately.

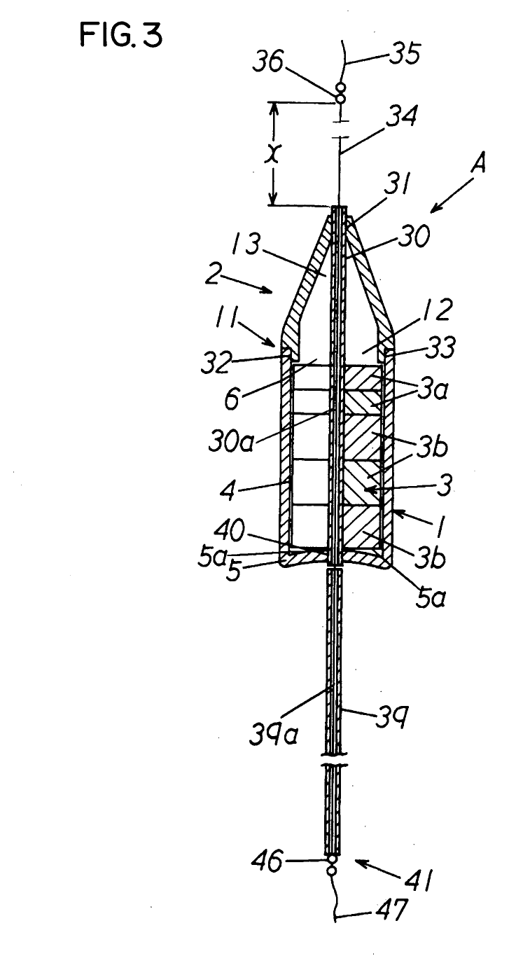

The first inner cylindrical member 30E and second inner cylindrical member 30F through which this connection fishing line 34 passes may be an integrated inner cylindrical member 30 which is connected continuously as shown in FIG. 3.

The inner cylindrical member 30 is formed into a pipe-like form having the hallow section 30a containing a hallow inner section made of synthetic resin or the like and inserted into an engaging hole 40 in the accommodation main body 1 and a through hole 31 in the lid body 2 substantially in the center of the accommodation main body 1 and lid body 2 in the axial direction of the accommodation main body 1 and lid body 2.

When the inner cylindrical member 30 is installed onto the accommodation main body 1 and the lid body 2, the through hole 31 in the accommodation main body 1 engages the outer peripheral section of the inner cylindrical member 30 slidably, thereby facilitating removal of the lid body 2 when the weight body 3 is replaced.

Further, the accommodation main body 1 and the inner cylindrical member 30 are formed integrally depending on the case.

The connection fishing line 34 is passed through the hallow sections 30Ea, 30Fa, 30a in the first inner cylindrical member 30E, the second inner cylindrical member 30F and inner cylindrical member 30 such that it can move freely in the axial direction (longitudinal direction). Both end sections thereof are provided so as to be extended from the outer end sections of the accommodation main body 1 and the lid body 2 (such that the connection fishing line 34 passing through the accommodation main body 1 and the lid body 2 is projected at a predetermined length continuously from the outer end sections of the accommodation main body 1 and the lid body 2). Consequently, the connection fishing line 34 can be protected from making frictional contact with other thing and being broken out.

The top end section of this connection fishing line 34 is attached to the line 35 connected to a fishing rod (not shown) through a swivel 36.

If the inside diameter of the hallow section 30a formed within the inner cylindrical member 30 is so formed that the inside diameter D1 of a front end section 30b of the inner cylindrical member 30 is larger than the inside diameter D2 of a rear end section 30c of this inner cylindrical member 30 (D1<D2) or to be tapered toward the advance direction of the fishing gear A (direction of an arrow Q in the same Figure), even if foreign matter such as water and sand invades into the inside of the inner cylindrical member 30, that foreign matter can be discharged smoothly and further, the connection fishing line 34 is protected from being damaged or broken due to friction and the like by the included sand or the like.

By forming the hallow section 30a in the tapered form, contact friction of the connection fishing line 34 against the inner wall of the inner cylindrical member 30 can be decreased as much as possible, thereby improving detection of a strike.

The inside diameter of the hallow section 30a formed within this inner cylindrical member 30 may be formed into a straight form, namely so that the entire diameter is equal (D1=D2) in as well as in the tapered form.

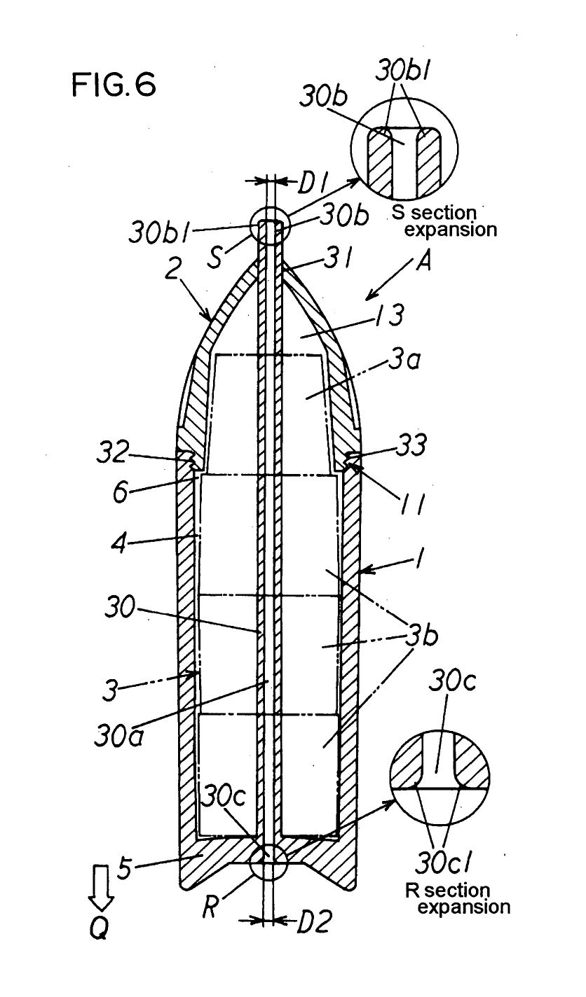

If an inner edge 30b1 and an outer edge 30c1 of the front end section 30b and the rear end section 30c respectively in the first inner cylindrical member 30E, the second inner cylindrical member 30F or the inner cylindrical member 30 are provided with a curved shape (rounded surface) as indicated in S section enlarged diagram and R section enlarged diagram in FIGS. 5, 6, contact with the connection fishing line 34 is made flexible so that the connection fishing line 34 is protected from being damaged when it is used for fishing or this fishing gear A is stored.

Even if the continuous inner cylindrical member 30 is not provided integrally with the accommodation main body 1, the inner edge 30b1 and the outer edge 30c1 of the front end section 30b and the rear end section 30c can be provided with the curved shape (rounded surface).

Even if the inner edge and outer edge 30b1, 30c1 are formed at right angle without being provided with the curved shape (rounded surface), there may be no problem as the fishing gear depending on the case although the connection fishing line 34 may be damaged.

The aforementioned weight body 3 provides the fishing gear with a predetermined weight action and can be formed of any material as long as it can achieve the above-described object even if it is not made of lead.

The weight is accommodated in the hallow section 4 of the accommodation main body 1 and the space section 13 of the lid body 2 such that they can be brought in and out freely. The weight has an outside diameter which allows itself to be accommodated in the accommodation main body 1 and plural pieces of the weights are provided in the space section 4. As shown in FIGS. 1-3 and others, as the plural weights 3, small weights 3a, 3b, . . . each having a different size (namely weight) are prepared and by combining these plural small weights 3a, 3b, . . . for accommodation, the weight body 3 having a desired entire weight is obtained. For example, the weight body 3 having the desired weight is obtained with three small weights 3b and a small weight 3a and other weights can be obtained by adjusting the combination. The entire weight can be adjusted finely.

Further, this weight body 3 can be accommodated in not only the cavity section 4 within the accommodation main body 1 but also in the space section 13 of the lid body 2 together with the cavity section 4 within the accommodation main body 1.

The accommodation volume for the weight body 3 within the cavity section 4 of the accommodation main body 1 is provided so as to be larger than the accommodation volume for the weight body 3 within the space section 13 in the lid body 2, namely a gravity center of the fishing gear A is provided on the side of the accommodating main body 1.

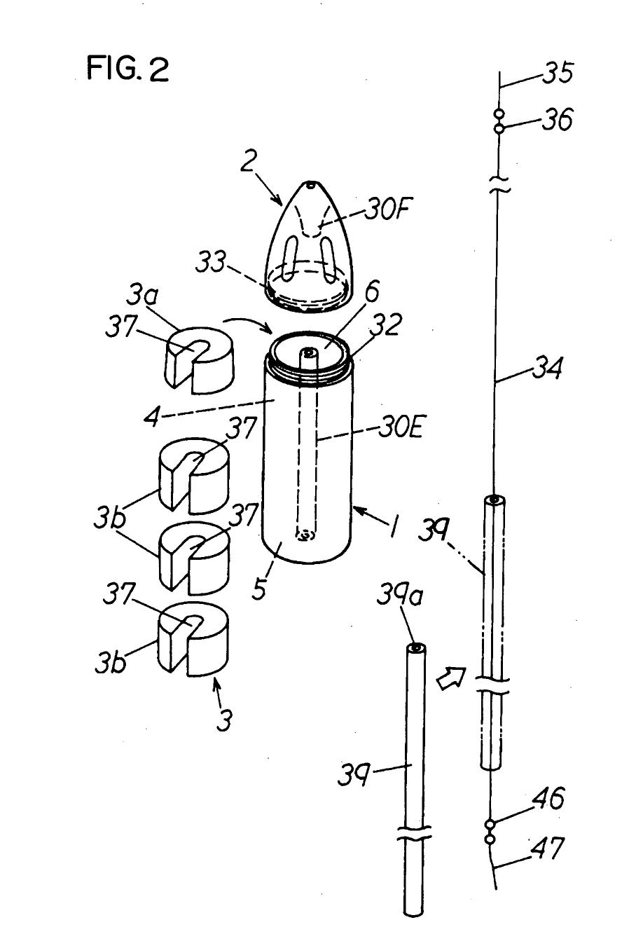

To secure an excellent storage performance into the cavity section 4 of the accommodation main body 1 and the space section 2 of the lid body 2, this weight body 3 is provided with a cutout 37 in order to avoid an interference with the first inner cylindrical member 30E, the second inner cylindrical member 30F or the inner cylindrical member 30. Consequently, as shown in FIG. 2 and others, the weights 3 can be attached to or detached from the first inner cylindrical member 30E, the second inner cylindrical member 30F or the inner cylindrical member 30 from outside of the first inner cylindrical member 30E, the second inner cylindrical member 30F or the inner cylindrical member 30.

A protective member 39 is engaged with the connection fishing line 34 protruded from the outer end section of the accommodation main body 1. This engagement is performed by passing the connection fishing line 34 through the pipe-like protective member 39. Within the protective member 39, a vacant hallow section 39a is formed and that hallow section 39a may be formed so that the inner diameter is expanded from a top section D3 to a bottom section D4 in the tapered form. Consequently, even if foreign matter such as water and sand invades into the hallow section 39a, that foreign matter can be discharged smoothly and the connection fishing line 34 is protected from being damaged due to friction or the like by the included sand or the like.

By forming the hallow section 39a in the tapered form as described above, the contact friction of the connection fishing line 34 against the inner wall of this protective member 39 can be decreased as much as possible, thereby improving detection of a strike.

The inside diameter of the hallow section 39a formed within this protective member 39 may be formed in the straight form, namely so that the diameter of the top section D3 is equal to the diameter of the bottom section D4 as well as in the above-described tapered form.

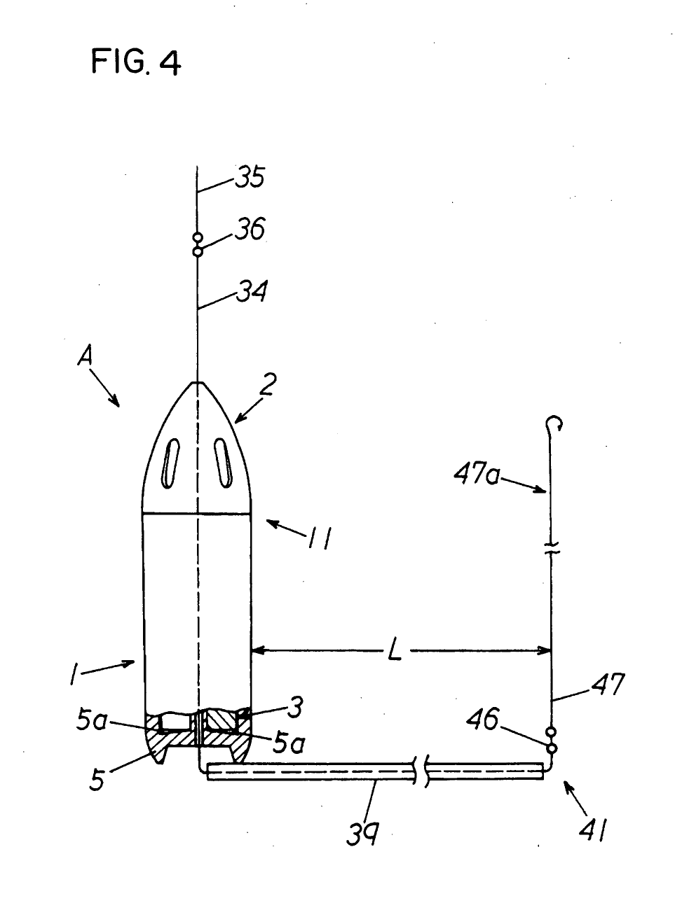

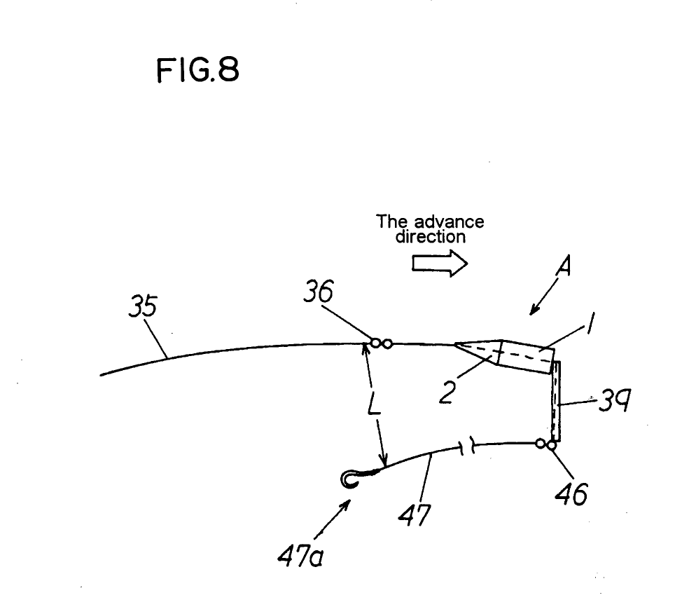

This protective member 39 prevents bait or the like attached to the terminal tackle 47a from clinging to the fishing gear A or fishing gut when the terminal tackle connected to the bottom of the fishing gear A is thrown away as shown in FIGS. 4, 8.

Additionally, this protective member 39 eliminates contact friction against other things so as to protect the connection fishing line 34 from being cut out. By adjusting the length of the protective member 39 appropriately, clinging to the fishing gear A or fishing gut is prevented further without being affected by wind direction or wind force at a fishing site.

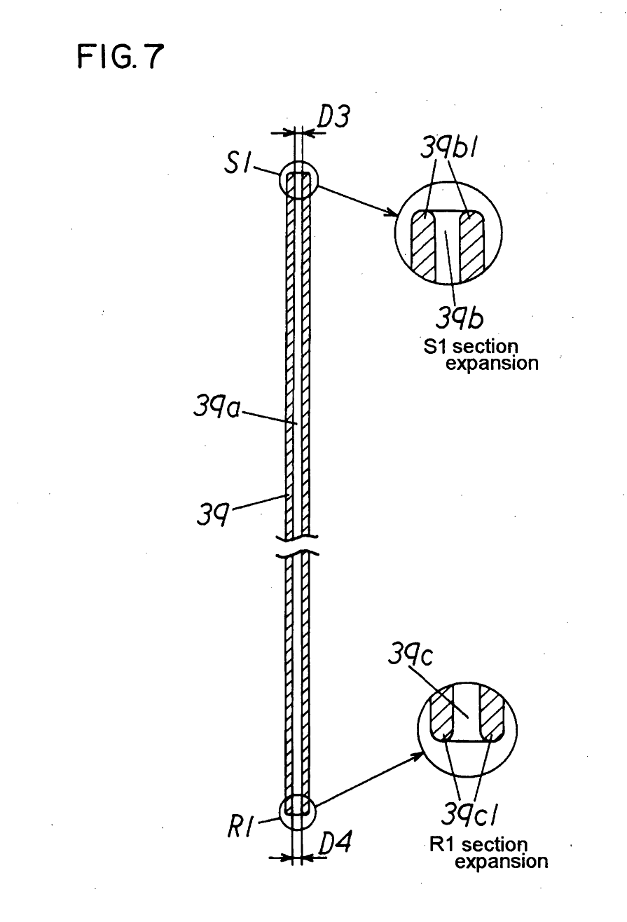

By providing the inner edge 39b1 and outer edge 39c1 of the front end section 39b and the rear end section 39c of the protective member 39 with the curved shape (rounded surface) as indicated in the S1 section enlargement diagram and R1 section enlargement diagram in FIG. 7, the contact with the connection fishing line 34 is made flexible and the connection fishing line 34 is protected from being damaged when it is used for fishing or this fishing gear A is stored.

There may be no problem in usage as the fishing gear even if the inner edge 39b1 and the outer edge 39c1 are formed at right angle without being provided with any curved shape (rounded surface), although the connection fishing line 34 may be damaged.

When this protective member 39 is attached to the connection fishing line 34, it is necessarily provided such that it is hung from the outer end section of the bottom section 5 of the accommodation main body 1 by attaching the fishing gear A to a predetermined position of the connection fishing line 34.

When attaching the integrated matter of the accommodation main body 1 and the lid body 2 of the fishing gear A to a predetermined position of the connection fishing line 34, a fixing means 41 for restricting a downward move in the length direction (axial direction) of the connection fishing line 34 is provided at the outer end section of the bottom section 5 of the accommodation main body 1. Consequently, a swivel 46 receives loads of the accommodation main body 1 containing the weight body 3, the lid body 2 and the protective member 39 in the fishing gear A.

That is, this fixing means 41 is so constructed that as shown in FIG. 1, the top end section of the protective member 39 whose bottom section is supported by the swivel 46 attached to the bottom end section of the connection fishing line 34 is kept in the vicinity (in contact with) the outer end section of the second inner cylindrical member 30F or the bottom end section of the inner cylindrical member 30, that is, the outer end section 5 of the bottom section of the accommodation main body 1.

When the top end section of the protective member 39 is in contact with the bottom end section of the second inner cylindrical member 30F or the inner cylindrical member 30, as shown in FIG. 1, a play x between the outer end section of the lid body 2 and the swivel 36 provided on the connection fishing line 34 above this outer end section serves as the level of a strike when a fish takes a bait.

The aforementioned protective member 39 is restricted from moving downward of the connection fishing line 34 when it is attached to the connection fishing line 34 by the swivel 46 attached to the bottom of the connection fishing line 34.

The terminal tackles 47a such as the weight and hook are connected to the down side of the swivel 46.

The top end section of the connection fishing line 34 passing through the inner cylindrical member 30 freely movably is connected to the line 35 and the terminal tackle 47a attached to a leader 47 is connected to the bottom end section of the connection fishing line 34. The connection fishing line 34, the line 35, and the leader 47 are fishing gut made of synthetic resin and the connection fishing line 34, the line 35 and the leader 47 are connected continuously. Consequently, a strike is transmitted directly from the terminal tackles 47a to the leader 47, the connection fishing line 34 and the line 35 so that it is finally sent to the fishing rod carried by a fisherman. Thus, this device can contribute to improvement of fishing achievement without losing the strike even if a small fish takes a bait or fish's pull is weak.

The fishing gear A of this embodiment having the above-described structure exerts following operation.

If this fishing gear A is used for surf casting on the sea (applicable for other fishing), the front end section of the line (upper fishing gut) 35 connected to a fishing rod is connected to the connection fishing line 34 in the fishing gear A through the swivel 36 and then, the terminal tackles 47a including the weight and hook and the like are connected to the connection fishing line 34 through the swivel 46.

The entire weight of the weight body 3 is selected corresponding to the situation (tidal flow, sea depth, kind of fish and the like) of a fishing site and the small weights 3a, 3b are accommodated in the cavity section 6 of the accommodation main body 1 and the space section 13 of the lid body 2 so as to obtain a desired weight body 3 and then, the accommodation main body 1 and the lid body 2 are coupled with each other by the fixing means 11.

Consequently, the entire terminal tackles for sea fishing are completed. If the terminal tackle 47a is thrown into the sea together with this fishing gear A, this fishing gear A which contains the weight flies to the sea with the terminal tackle 47 located below it in the advance direction (direction of an arrow Q indicated in FIGS. 5, 6).

Because in this fishing gear A, the connection fishing line 34 is surrounded by the protective member 39 below the bottom section of the accommodation main body 1, a predetermined shape maintaining action is applied to this fishing gear 34, so that as shown in FIGS. 4, 8, a predetermined gap L is formed between the terminal tackle 47 and the accommodation main body 1 and lid body 2 in the fishing gear A.

As a result, a hook or bait attached to the terminal tackle 47a does not cling to the fishing gear A or fishing gut (line 35).

Particularly because only the connection fishing line 34 below the bottom section of the accommodation main body 1 can swing freely, it allows the protective member 39 to be rotated arbitrarily (freely), thereby further preventing the terminal tackle 47a and the line 35 from clinging.

Further, if the bottom section 5 of the accommodation main body 1 is formed circularly or in a concave shape, the protective member 39 can bend easily up to substantially 90° as well as only the connection fishing line 34 can swing freely. Thus, the protective member 39 can maintain its posture at substantially 90° in the air after the fishing gut is thrown away.

If speaking about the fishing gear A of the present invention more in detail, if the top end of the fishing rod is swung largely toward the sea upon surf casting, the fishing gear A and terminal tackle 47a lead by the lead 35 fed from the fishing rod fly with the bottom section 5 of the accommodation main body 1 as a head along an arc and then submerge into the sea.

At this time, the fishing gear A containing the weight 3 flies in the air with the bottom section 5 of the accommodation main body 1 as the head as shown in FIG. 8, the protective member 39 located at a bent position takes a posture substantially at right angle to the line 35 and the terminal tackle 47a (including the leader 47) provided with the hook moves in parallel to the line 35 in the air.

That is, in the posture in the air, the predetermined gap L, which corresponds to the length of the protective member 39, is maintained to prevent the terminal tackle 47a (including the leader 47) from clinging to the line 35 as shown in FIGS. 4, 8.

Because as for the condition of bending in a direction substantially at right angle to the length direction of the line 35, the connection fishing line 34 having the protective member 39 can rotate in any direction of 360° with respect to the bottom section 5 of the accommodation main body 1, that posture substantially at right angle can be obtained smoothly even if the bending direction of the protective member 39 is changed by a wind pressure applied to the protective member 39, the leader 47 and terminal tackle 47a.

The features of the present invention exist in the structure which allows the protective member 39 to rotate freely with respect to the bottom section 5 of the accommodation main body 1 and that it is attached freely movably in the direction of the connection fishing line 34 as a means for maintaining the protective member 39 in a condition (posture) of bending substantially at right angle to the length direction of the line 35 in order to always maintain the predetermined gap L between the terminal tackle 47a and the line 35 when they fly in the air.

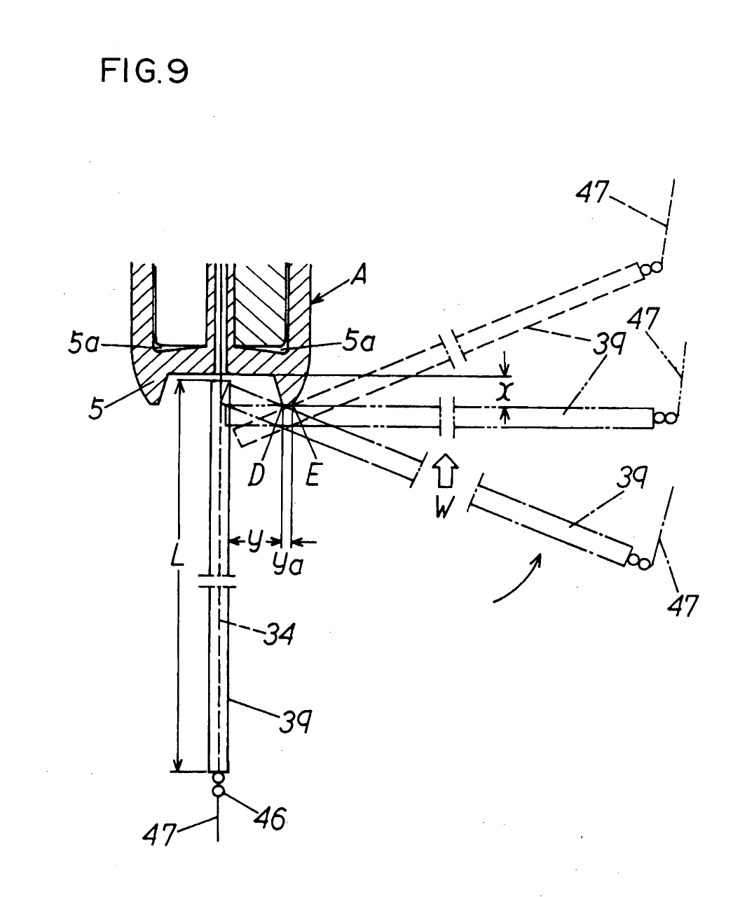

If speaking in detail, the condition in which the protective member 39 is bent substantially at right angle to maintain its basic posture is attained when as shown in FIG. 9, wind pressure moment (equally distributed load) M applied to the protective member 39 is approximate to a moment Md applied to a fulcrum point D when the protective member 39 is bent.

When the protective member 39 is kept in the condition indicated by two-dots and dash line in which it is bent substantially at 90° as shown in the same Figure, it comes that moment M=(L−y)/2×W where y: distance from the connection fishing line 34 up to the fulcrum point D, W: equally distributed load of wind pressure to the protective member 39 and moment Md=y^{x} (weight of accommodation main body 1+lid body 2+accommodated weight body 3)

According to the present invention, the protective member 39 bent with respect to the bottom section 5 of the accommodation main body 1 produces a lever application principle with the point D located at an end section of the accommodation main body 1 as a fulcrum point, so that it can maintain a posture bent substantially at right angle resisting the wind pressure. As a result, the terminal tackle 47a is thrown into water without clinging to the line 35 (see FIG. 9).

When the wind pressure is small or the total weight of the weight body 3 is small, the posture of the protective member 39 in the air is as indicated by a dot-and dash line in FIG. 9 because M≦Md.

If the weight of the weight body 3 is increased, the acceleration of the weight body section is increased and the wind pressure applied to the protective member 39 is also increased. As a result, the protective member 39 can be bent (M≧Me) to an angle over 90° (for example, 135°) with respect to the direction of the connection fishing line 34 as indicated by dotted line in FIG. 9. Due to this bending, the protective member 39 bent with respect to the bottom section 5 of the accommodation main body 1 is moved from fulcrum point D to the fulcrum point E on the outer peripheral section instantaneously. Consequently, it comes to moment M=((L−(y+ya))/2×W, where y: a distance from the connection fishing line 34 to the fulcrum point D, ya: a distance from y to the fulcrum point E, W: equally distributed load of wind pressure to the protective member 39, and moment Me=(y+ya)×(weight of accommodation main body 1+lid body 2+accommodated weight body 3). The bending of the protective member 39 is suppressed to an angle of 135°0 and the gap between the line 35 and the terminal tackle 47a is held to the predetermined gap L. As a result, the terminal tackle 47a is thrown into water without clinging to the line 35 (see FIG. 8). Therefore, by setting the dimensions x, y, ya indicated in FIG. 9 appropriately, the posture of the protective member 39 in the air can be set up to the basic posture indicated by two-dot and dash line in FIG. 9, thereby enabling design changes even if the total weight of the weight body 3 is changed or the length L is changed.

If the weight of the weight body 3 is unsatisfactory upon usage, the terminal tackle 47a is pulled out of the sea together with the fishing gear A and then, the accommodation main body 1 and the lid body 2 in the fishing gear A are separated through the fixing means 11, so that the weight body 3 can be removed (or replaced) or adjusted by adding other weight. If the quantity of the small weights 3a, 3b in the weight body 3 within the cavity section 6 and space section 13 is increased or decreased and the accommodation main body 1 and the lid body 2 are coupled with each other through the fixing means 11, fishing can be restarted immediately and adjustment of the weight of the weight body 3 does not need labor and time.

According to the present invention, the line 35 and the terminal tackle 47a are connected straight through the connection fishing line 34 not through the line attachment lever 72 and the leader attachment lever 73, both made of wire unlike the conventional balance weight 74. Thus, a strike of a hooked fish is transmitted directly from the terminal tackle 47a to the connection fishing line 34 and line 35, so that a reaction to the strike of a fisherman becomes keen thereby leading to a further increase of fishing result.

1. A fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of said accommodation main body and the space section in the lid body, wherein said lid body is formed substantially conically such that it is narrowed gradually from the opening section of said accommodation main body, a first inner cylindrical member is provided in the center of the cavity section in said accommodation main body toward said lid body so that an end section thereof is in contact with the bottom section of the accommodation main body while the other end section of the first inner cylindrical member is extended up to the opening section in said accommodation main body, a second inner cylindrical member is provided in the center of the space section in said lid body toward the accommodation main body so that it is in contact with the end section of the substantially conical section of the lid body while a predetermined separation gap is formed between the other end of the second inner cylindrical member and the other end section of the first inner cylindrical member thereby preventing both the other end sections from making contact, and a connection fishing line is passed through the inner cylindrical member freely movably so that both the end sections of the connection fishing line are brought out of the outer end sections of said accommodation main body and said lid body.

2. A fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of said accommodation main body and the space section in the lid body, wherein said lid body is formed substantially conically such that it is narrowed gradually from the opening section of said accommodation main body, an inner cylindrical member is provided substantially in the center section of the accommodation main body and lid body in the axial direction of said accommodation main body and said lid body, a connection fishing line is passed through the inner cylindrical member freely movably so that both the end sections of the connection fishing line are brought out of the outer end sections of said accommodation main body and said lid body, a protective member is engaged with said connection fishing line protruded from the side of said accommodation main body, and said connection fishing line is provided with a means for restricting a move of the connection fishing line in the length direction thereof at the bottom section of said accommodation main body.

3. A fishing gear comprising: a cylindrical accommodation main body in which a cavity section is formed internally, a bottom section is provided on a side section thereof and an opening section is provided on the other side section; a lid body provided freely detachably on an opening section of the accommodation main body through the fixing means; and plural weight bodies which are accommodated in the cavity section of said accommodation main body and the space section in the lid body, wherein said lid body is formed substantially conically such that it is narrowed gradually from the opening section of said accommodation main body, a first inner cylindrical member is provided in the center of the cavity section in said accommodation main body toward said lid body so that an end section thereof is in contact with the bottom section of the accommodation main body while the other end section of the first inner cylindrical member is extended up to the opening section in said accommodation main body, a second inner cylindrical member is provided in the center of the space section in said lid body toward the accommodation main body so that it is in contact with the end section of the substantially conical section of the lid body while a predetermined separation gap is formed between the other end of the second inner cylindrical member and the other end section of the first inner cylindrical member thereby preventing both the other end sections from making contact, a protective member which is a member separate from said second inner cylindrical member is engaged with said connection fishing line protruded from the side of said accommodation main body while this engagement is performed by passing said connection fishing line through a hallow section in said protective member, the connection fishing line is provided such that it can swing freely around the outer end section of the bottom of said accommodation main body, so that said protective member engaged with the connection fishing line can rotate freely sideway and said connection fishing line is provided with a means for restricting a move of the connection fishing line in the length direction thereof at the bottom section of said accommodation main body.

4. The fishing gear according to claim 1 wherein the top end of the connection fishing line passed through the first inner cylindrical member and the second inner cylindrical member freely movably is connected to a line and a terminal tackle attached to a leader is connected to the bottom end of said connection fishing line, and said connection fishing line, said line and said leader are made of fishing gut and said connection fishing line, said line and said leader are connected straight to each other.

5. The fishing gear according to claim 2 wherein the inside diameter of the hallow section formed within the inner cylindrical member is formed in a tapered form such that the inside diameter of the rear end section of the inner cylindrical member is larger than the inside diameter of the front end section of the inner cylindrical member.
